(19) United States
(12) Patent Application Publication
(10) Pub. No.: US 2025/0180599 A1
(43) Pub. Date: Jun. 5, 2025

(54) WEARABLE DEVICE IMU INTRINSIC CALIBRATION

(71) Applicant: Google LLC, Mountain View, CA (US)

(72) Inventors: Qiyue Zhang, Santa Clara, CA (US); Zhiheng Jia, Sunnyvale, CA (US); Joshua Anthony Hernandez, Redwood City, CA (US)

(21) Appl. No.: 18/526,312

(22) Filed: Dec. 1, 2023

(51) Int. Cl. G01P 21/00; G01C 25/00

(52) U.S. Cl. CPC G01P 21/00; G01C 25/00

(57) ABSTRACT

A method including during a calibration operation, establishing communication with a test fixture, via a communication channel between the test fixture and a head mounted device (HMD), during the calibration operation, obtaining inertial measurement unit (IMU) data based on output from an IMU in the HMD generated based on movement of the HMD caused by a text fixture to which the HMD is coupled, during the calibration operation, generating IMU calibration data for the HMD based on the IMU data, during the calibration operation, store the IMU calibration data in the HMD, and after the calibration operation is completed (or in response to completing the calibration operation), implement at least one technical measure to prevent subsequent modification of the IMU calibration data.

### FIELD

Implementations relate to calibrating a wearable device (e.g., a head mounted display) inertial measurement unit (IMU).

### BACKGROUND

There are at least two ways to perform calibration of an IMU. One is to calibrate the IMU on a precision device that is used for lab experimentation and/or for industrial IMU calibration. The precision calibration devices used in a lab or for industrial purposes can be too expensive for consumer product calibration. Another way to calibrate the IMU is to use an All in One (AIO) calibration system and perform camera/IMU integrated calibration. The AIO calibration system can also be complicated and expensive (e.g., equipment and time) because processing the data from the AIO calibration system includes image processing.

### SUMMARY

Implementations relate to calibrating the IMU of a wearable device while mounted in a test fixture. The wearable device can be in shipping and/or display packaging when mounted in a test fixture. While the wearable device is in the shipping and/or display packaging of the wearable device and is in the test fixture, the test fixture while coupled to the wearable device is repositioned along at least one of an x, y, z axes and IMU data (e.g., gyroscope data and accelerometer data) is recorded. Calibration (e.g., intrinsic) parameters can be generated based on the IMU data and stored in a memory associated with (e.g., disposed within) the IMU. In some implementations, the calibration can be controlled by the wearable device and/or the test fixture. In addition, calibrating the IMU while installed in the wearable device can correct for IMU errors introduced by the wearable device and/or manufacturing the wearable device.

In some implementations, communication can be established between the test fixture and the wearable device. In response to completing the calibration, the communication can be disabled on the wearable device. Disabling the communication channel on the wearable device can prevent inadvertent and/or nefarious changes to the calibration data via the communication channel.

In a general aspect, a device, a system, a non-transitory computer-readable medium (having stored thereon computer executable program code which can be executed on a computer system), and/or a method can perform a process with a method including during a calibration operation, establishing communication with a test fixture, via a communication channel between the test fixture and a head mounted device (HMD), during the calibration operation, obtaining inertial measurement unit (IMU) data based on output from an IMU in the HMD generated based on movement of the HMD caused by a text fixture to which the HMD is coupled, during the calibration operation, generating IMU calibration data for the HMD based on the IMU data, during the calibration operation, store the IMU calibration data in the HMD, and after the calibration operation is completed (or in response to completing the calibration operation), implement at least one technical measure to prevent subsequent modification of the IMU calibration data.

In another general aspect, a device, a system, a non-transitory computer-readable medium (having stored thereon computer executable program code which can be executed on a computer system), and/or a method can perform a process with a method including establishing communication with a test fixture, via a communication channel, to initialize the test fixture, recording inertial measurement unit (IMU) data within a head mounted display (HMD) in response to repositioning of the HMD while coupled to the test fixture, generating IMU calibration data for the HMD based on the IMU data, and preventing, after the calibration operation is completed, modification of the IMU calibration data.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A illustrates a wearable device IMU calibration system according to an example implementation.

FIG. 1B illustrates a wearable device in shipping packaging IMU calibration system according to an example implementation.

FIG. 2 illustrates a block diagram of a computing system according to an example implementation.

FIG. 3 illustrates a method of calibrating a wearable device IMU according to an example implementation.

FIG. 4 illustrates another method of calibrating a wearable device IMU according to an example implementation.

FIG. 5 illustrates yet another method of calibrating a wearable device IMU according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

A problem with existing IMU calibration systems is that the calibration systems can be complicated to use and/or cost prohibitive for manufacturing processes, repair processes, and the like when calibrating the IMU installed in a wearable device. For example, existing IMU calibration systems are complicated, costly and used in a laboratory environment. Therefore, calibrating the IMU while manufacturing the wearable device can add time and cost to the manufacturing process. Further, the complexity of existing IMU calibration systems can require the use of highly trained calibration technicians that are not usually available to be included as operators in an assembly line. At least one technical solution, as described herein, can be to calibrate the IMU in a wearable device using the wearable device to control a test fixture that is communicatively coupled to the wearable device. In some implementations, the wearable device can be configured to control movement of the test fixture. In some implementations, the wearable device can be configured to control capturing and storing of IMU measurements. In some implementations, the test fixture can be configured to control capturing and storing of IMU measurements.

At least one technical effect of this solution can be that the calibration is controlled by the wearable device and/or the test fixture while the wearable device is in shipping and/or display packaging. The calibration can be performed in manufacturing and repair facilities without complicated and/or cost prohibitive calibration equipment. Further, using the wearable device to control the calibration does not add significant cost to the manufacturing and/or repair of the wearable device because separate systems are not necessary. In other words, the technical solution does not use an IMU calibration system that is separate from the manufacturing process, the technical solution does not use an IMU calibration system that is complicated, costly and used in a laboratory environment. In addition, calibrating the IMU while installed in the wearable device can correct for errors introduced by the wearable device and/or manufacturing the wearable device. Further, in response to completing the IMU calibration modification of the IMU calibration data can be prevented in order to prevent inadvertent and/or nefarious changes to the calibration data. For example, in some implementations the communication channel on the wearable device can be disabled.

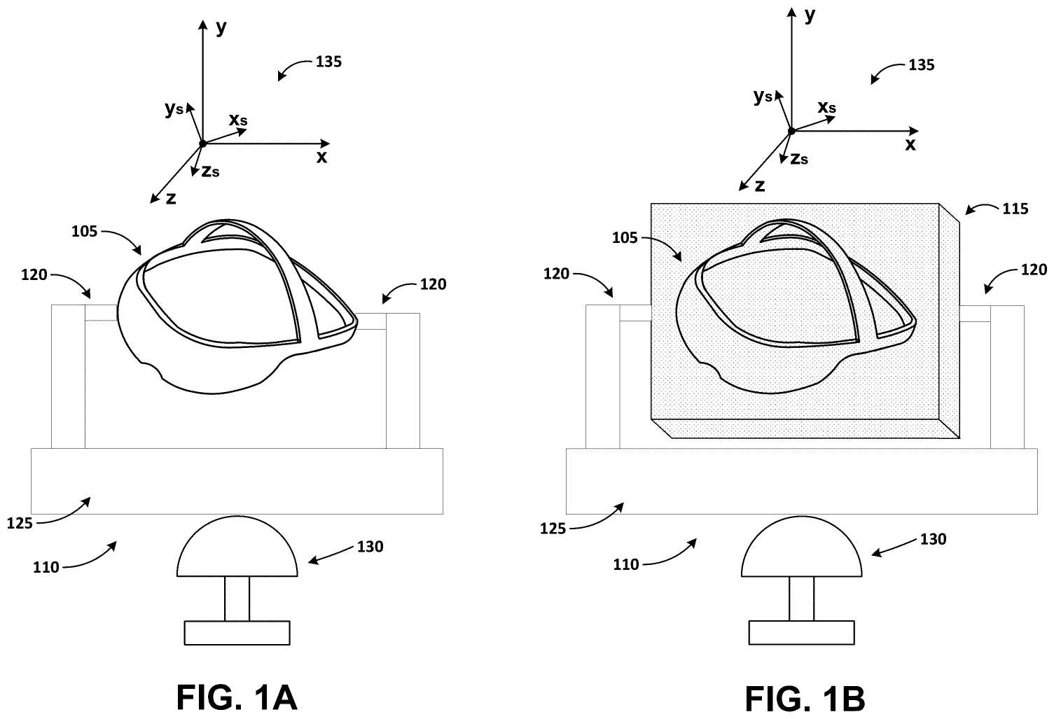

FIG. 1A illustrates a wearable device IMU calibration system according to an example implementation. FIG. 1B illustrates a wearable device in shipping packaging IMU calibration system according to an example implementation. As shown in FIGS. 1A and 1B, a wearable device 105 is coupled to a test fixture 110. As shown in FIG. 1B, the wearable device 105 can be included in box 115. In some implementations, box 115 can be a shipping box, a product display box, an aftermarket box, a resale box, a repair box, and the like. In other words, box 115 can be a disposable (e.g., made of cardboard) box that the wearable device 105 can be positioned (e.g., located, placed, installed, and the like) in. The wearable device 105 can be securely (e.g., prevented from moving) positioned in box 115. The wearable device can include head mounted displays (HMD), virtual reality (VR) headset, augmented reality (AR) headset, smartglasses, and/or the like. Securing the wearable device 105 ensures that repositioning the test fixture 110 causes the box 115 and the wearable device 105 to move together without any additional movement of the wearable device 105. This can ensure that the IMU can be calibrated with known movements. The wearable device 105 can be securely positioned in box 105 using packaging material (e.g., styrofoam, bubble wrap, paper, cardboard, and the like).

The test fixture 110 can include a coupling element 120 configured to couple the wearable device 105 and/or the box 115 to the test fixture 110. The test fixture 110 can include a reposition element 125 configured to move along the x, y, z axes. The reposition element 125 can be configured to move along one or any combination of the x, y, z axes. The test fixture 110 can include a pivot element 130 coupled to the reposition element 125 and on which the reposition element 125 moves along the x, y, z axes. Although an example implementation of the test fixture 110 is illustrated and described, other test fixture constructions can be used. However, the test fixture 110 is configured to reposition the wearable device 105 and/or the box 115 along the x, y, z axes.

In some implementations, the wearable device 105 includes and/or is associated with a computing system (not shown) and the test fixture 110 includes and/or is associated with a computing system (not shown). In some implementations, the wearable device 105 can be communicatively coupled (wireless and/or wired) with the test fixture 110. In some implementations, the wearable device 105 and/or the test fixture 110 can be configured to use a communication channel reserved for an IMU calibration operation and/or process. For example, the communication channel reserved for the IMU calibration operation and/or process can be disabled in response to ending the IMU calibration process. For example, the communication channel reserved for the IMU calibration operation and/or process can be disconnected in response to ending the IMU calibration operation and/or process. In other words, if an IMU is not being calibrated, the communication channel reserved for the IMU calibration operation and/or process is not in use and can be prevented from being used for any communication other than a communication associated with an IMU calibration operation and/or process. In some implementations, after completion of the calibration operation and/or process modification of the IMU calibration data can be prevented. For example, preventing the modification of the IMU calibration data can include triggering a command that disables the communication channel on the wearable device 105. A technical advantage of using the communication channel reserved for the IMU calibration operation and/or process can be that software, processing, data, and the like can be isolated from being accessed during normal and/or nefarious use of the wearable device 105.

Further illustrated in FIGS. 1A and 1B is a three-dimensional (3D) cartesian coordinate system 135 including right-handed orthogonal coordinates (x, y, z) as a virtual (platform) IMU coordinates (p frame) and non-orthogonal coordinates (xₛ, yₛ, zₛ) as a sensor frame (s frame). In some implementations, the non-orthogonal coordinates (xₛ, yₛ, zₛ) can illustrate misalignment angles between the s frame and the p frame for which a calibration operation and/or process is configured to minimize the effect of on IMU measurements and/or data.

In an example use case, the wearable device 105 can be included in box 115 as the packaging box that the wearable device 105 will be displayed in on a store shelf. For example, on a product assembly line the wearable device 105 can be assembled from parts including the IMU. The IMU may have been calibrated (e.g., a factory calibration) when manufactured. However, being assembled into the wearable device 105 can introduce the possibility of measurement error that cannot be accounted for when the IMU is manufactured. Alternatively, the IMU may not be calibrated when manufactured. While on the assembly line, the IMU can be inserted into box 115 and held securely using some packaging material. In some implementations, the packaging material can be configured to position and orthogonally align the IMU within box 115. At the end of the manufacturing line, after boxing and before preparing for shipment, box 115 including the wearable device 105 can be coupled to the test fixture 110 and the IMU can be calibrated as described herein.

In another use case, the IMU can be calibrated prior to being delivered to a customer. For example, the packaged wearable device 105 can be stored in a warehouse (e.g., a distribution center). Prior to being delivered to a customer (e.g., user), box 115 including the wearable device 105 can be coupled to the test fixture 110 and the IMU can be calibrated as described herein. In yet another use case, the wearable device 105 can be repaired by a repair technician. After completing the repair, the technician can insert the repaired wearable device 105 into box 115 and held securely using some packaging material. In some implementations, the packaging material can be configured to position and orthogonally align the wearable device 105 within box 115. After boxing the wearable device 105 can be coupled to the test fixture 110 and the IMU can be calibrated as described herein before returning the wearable device 105 to the owner of the wearable device 105.

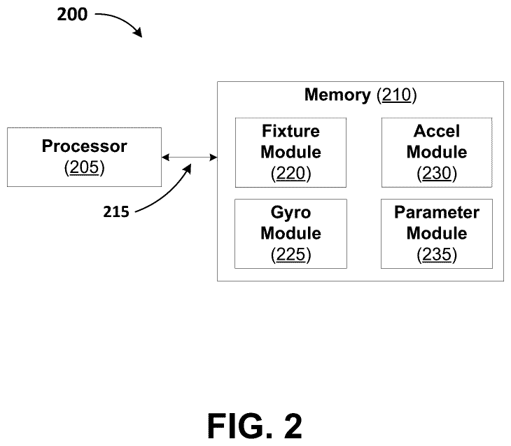

FIG. 2 illustrates a block diagram of a computing system 200 according to an example implementation. As shown in FIG. 2, the computing system 200 can include a processor 205 and a memory 210. The processor 205 and the memory 210 can be communicatively coupled via a bus 215. The memory 210 can include a fixture module 220 block, a gyro module 225 block, an accel module 230 block, and a parameter module 235 block.

In some implementations, the processor 205 may be utilized to execute instructions stored on the memory 210. Therefore, the processor 205 can implement the various features and functions described herein, or additional or alternative features and functions. The processor 205 and the memory 210 may be utilized for various other purposes. For example, the memory 210 may represent an example of various types of memory and related hardware and software which may be used to implement any one of the modules described herein. The processor 205 may be a shared resource. For example, the computing system 200 may be an element of a larger system. Therefore, the processor 205 may be configured to execute computer instructions associated with other elements (e.g., web browsing or wired/wireless communication) within the larger system.

The memory 210 may be configured to store data and/or information associated with calibrating an IMU of a wearable device. The memory 210 may be a shared resource. For example, the computing system 200 may be an element of a larger system. Therefore, the memory 210 may be configured to store data and/or information associated with other elements (e.g., web browsing or wired/wireless communication) within the larger system.

The fixture module 220 can be configured to reposition the wearable device 105 and/or the box 115. For example, the fixture module 220 can be configured to cause the reposition element 125 to move along one or any combination of the x, y, z axes. In some implementations, the fixture module 220 can be configured to initialize the test fixture 110 including causing a leveling of the test fixture. A leveling of the test fixture can include positioning the test fixture (e.g., reposition element 125), the wearable device 105 and/or the box 115 to a level or zeroed orthogonal position. In other words, the right-handed orthogonal coordinates (x, y, z) or p frame have a zero offset. In some implementations, the computing system 200 may be included in the wearable device 105. Therefore, causing the reposition element 125 to move (e.g., for leveling and/or calibration repositioning) along one or any combination of the x, y, z axes can include communicating an instruction, command, and the like (e.g., computer code including a command to move) from the wearable device 105 to the test fixture 110.

The gyro module 225 can be configured to receive IMU calibration data (e.g., gyroscope data) including, for example, data sampling time tags (t), IMU (or gyroscope) rotation rate measurement along the x (ωₓ), y (ω_{y}), and z (ω_{z}) axes. Alternatively, or in addition, the gyro module 225 can be configured to calculate, generate, determine, and/or the like a gyroscope scale factor and a gyroscope misalignment along the rotation axis based on the received IMU calibration data. In some implementations, the IMU calibration data can be gyroscope data including angular data associated with the non-orthogonal coordinates (xₛ, yₛ, zₛ) or s frame. In some implementations, the computing system 200 may be included in the test fixture 110. Therefore, receiving the IMU calibration data can include communicating data from the wearable device 105 to the test fixture 110.

The accel module 230 can be configured to receive IMU calibration data (e.g., accelerometer data) including, for example, data sampling time tags (t), the apparent acceleration measurements along the x (αₓ), y (α_{y}), and z (α_{z}) axes. In some implementations, the apparent acceleration can include gravity and translational acceleration. Alternatively, or in addition, the accel module 230 can be configured to calculate, generate, determine, and/or the like an accelerometer misalignment matrix based on the received IMU calibration data. In some implementations, the IMU calibration data can be accelerometer data including angular data associated with the non-orthogonal coordinates (xₛ, yₛ, zₛ) or s frame, angular velocity, acceleration including gravity, and/or the like. In some implementations, the computing system 200 may be included in test fixture 110. Therefore, receiving the IMU calibration data can include communicating data from the wearable device 105 to the test fixture 110.

The parameter module 235 can be configured to calculate intrinsic parameters (sometimes called persistent values) used to calibrate the IMU. The intrinsic parameters can be used to correct IMU measurement errors. The parameter module 235 can be configured to store the intrinsic parameters in a memory (e.g., eeprom) associated with the IMU.

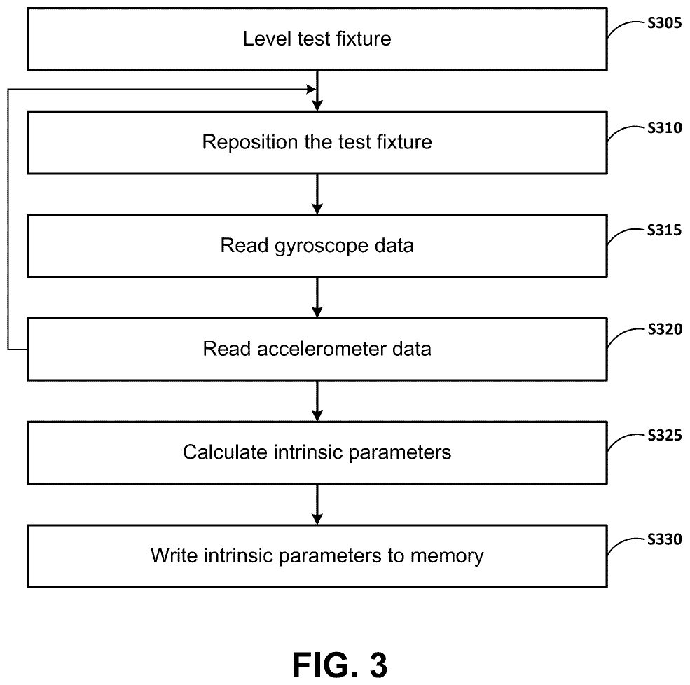

FIG. 3 illustrates a method of calibrating a wearable device IMU according to an example implementation. In some implementations, the steps of FIG. 3 can be controlled by the wearable device. In some implementations, the steps of FIG. 3 can be controlled by the test fixture. In some implementations, the steps of FIG. 3 can include establishing a communication channel (e.g., communicatively coupling) between the wearable device and the test fixture. In some implementations the IMU of the wearable device (e.g., wearable device 105) can be calibrated as a standalone device (e.g., absent any packaging. In some implementations the IMU of the wearable device can be calibrated while in a package (e.g., box 115). Prior to calibrating the wearable device, the wearable device or the packaging including the wearable device is coupled to a test fixture (e.g., test fixture 110).

As shown in FIG. 3, in step S305, a test fixture is leveled. In some implementations, the fixture module 220 can be configured to initialize the test fixture 110 including causing a leveling of the test fixture. A leveling of the test fixture can include positioning the test fixture (e.g., reposition element 125), the wearable device 105 and/or the box 115 to a level or a zeroed orthogonal position. In other words, the right-handed orthogonal coordinates (x, y, z) or p frame has a zero offset.

In step S310 the test fixture is repositioned. For example, the fixture module 220 can be configured to cause the reposition element 125 to move along one or any combination of the x, y, z axes. As shown in FIG. 3, the test fixture (e.g., test fixture 110) can be repositioned (and the following steps performed) multiple times. For example, the test fixture can be repositioned (e.g., moved) along the x axis and the following steps performed. In some implementations, the test fixture is repositioned along the x axis and the following steps are performed multiple times. Then, for example, the test fixture can be repositioned (e.g., moved) along the y axis and the following steps performed. In some implementations, the test fixture is repositioned along the y axis and the following steps are performed multiple times. Then, for example, the test fixture can be repositioned (e.g., moved) along the z axis and the following steps performed. In some implementations, the test fixture is repositioned along the z axis and the following steps are performed multiple times.

In step S315 gyroscope data (e.g., angular velocity) is read. For example, the IMU of the wearable device can include a gyroscope. The gyroscope data can include, for example, data sampling time tags (t), IMU (or gyroscope) rotation rate measurement along the x (ωₓ), y (ω_{y}), and z (ω_{z}) axes. In response to the test fixture being repositioned, gyroscope data can be read. In some implementations, the gyroscope data can be read a period of time (e.g., 5, 10, 15, and the like seconds) after the repositioning. In some implementations, the test fixture (e.g., test fixture 110) can be repositioned multiple times. Accordingly, gyroscope data can be read multiple times (e.g., after each repositioning of the test fixture).

In step S320 accelerometer data is read. For example, the IMU of the wearable device can include an accelerometer. The accelerometer data can include, for example, data sampling time tags (t), the apparent acceleration measurements along the x (αₓ), y (α_{y}), and z (α_{z}) axes. In some implementations, the apparent acceleration can include gravity and translational acceleration. In response to the test fixture being repositioned, accelerometer data can be read from the accelerometer. In some implementations, the accelerometer data can be read a period of time (e.g., 5, 10, 15, and the like seconds) after the repositioning. In some implementations, the test fixture (e.g., test fixture 110) can be repositioned multiple times. Accordingly, accelerometer data can be read multiple times (e.g., after each repositioning of the test fixture).

In step S325 intrinsic parameters are calculated. In some implementations, the intrinsic parameters can be an accelerometer misalignment matrix and gyroscope misalignment matrix. In some implementations, the test fixture (e.g., test fixture 110) can be repositioned multiple times. Therefore, the accelerometer misalignment matrix and the gyroscope misalignment matrix can be calculated based on the gyroscope data and the accelerometer data (or a subset of the data) captured after the multiple repositionings. In some implementations, the accelerometer misalignment matrix and the gyroscope misalignment matrix can be calculated, computed, determined, and the like as follows.

In some implementations, the right-handed orthogonal coordinates (x, y, z) (e.g., of the 3D cartesian coordinate system 135) can be the virtual (platform) IMU coordinates (p frame) and the non-orthogonal coordinates (xₛ, yₛ, zₛ) (e.g., of the 3D cartesian coordinate system 135) can be the sensor frame (s frame). The misalignment angles (e.g., IMU errors) between s frame and p frame can be small (e.g., less than 5 degrees). In some implementations, cos (9)=1 and sin (9)=9 can be used to indicate error in IMU measurement. Therefore, an accelerometer error model can be written as:

$${α}^{s a} = {S}_{a} {M}_{a} {α}^{p} + {b}_{a}^{sa} + {n}^{sa} \qquad ( 1 )$$

and a gyroscope error model can be written as:

$${ω}^{sg} = {S}_{g} {M}_{g} {ω}^{p} + {b}_{g}^{sg} + {n}^{sg} \qquad ( 2 )$$

where,
ω is the angular velocity,
α is the apparent acceleration (including gravity),
s is the sensor frame,
p is the platform frame,
n is the noise,
S is the scale factor matrix,
M is the misalignment matrix,
a is the accelerometer,
g is the gyroscope, and
b is the bias vector.
   For example, b_{g}^{sg} denotes gyro bias expressed in the gyro sensor frame.

$${S}_{g} = diagonal [ {S}_{gx} , {S}_{gy} , {S}_{gz} ] \qquad ( 3 )$$

$${M}_{g} = [ \begin{matrix}1 & {m}_{gyx} & {m}_{gzx} \\ {m}_{gyx} & 1 & {m}_{gzy} \\ {m}_{gxz} & {m}_{gyz} & 1\end{matrix} ] \qquad ( 4 )$$

$${S}_{a} = diagonal [ {S}_{ax} , {S}_{ay} , {S}_{az} ] \qquad ( 5 )$$

$${M}_{a} = [ \begin{matrix}1 & {m}_{ayx} & {m}_{azx} \\ {m}_{ayx} & 1 & {m}_{azy} \\ {m}_{axz} & {m}_{ayz} & 1\end{matrix} ] \qquad ( 6 )$$

In some implementations, accelerometer calibration can be written as:

$$bias = ( {α}^{sa} \_up + {α}^{sa} \_down ) / 2 \qquad ( 7 )$$

$$scale factor = ( {α}_{up}^{sa} - {α}_{down}^{sa} ) / 2 * 9.8 \qquad ( 8 )$$

Further, a misalignment matrix element can be computed with the accelerometer measurement when an axis is in a horizontal position, such as:

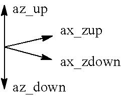

$${m}_{axz} = ( ax\_zup - ax\_zdown ) / 2 * 9.8 \qquad ( 9 )$$

$${m}_{ayz} = ( ay\_zup - ay\_zdown ) / 2 * 9.8 \qquad ( 10 )$$

$${m}_{axy} = ( ax\_yup - ax\_ydown ) / 2 * 9.8 \qquad ( 11 )$$

$${m}_{azy} = ( az\_zup - az\_zdown ) / 2 * 9.8 \qquad ( 12 )$$

$${m}_{ayx} = ( ay\_xup - ay\_xdown ) / 2 * 9.8 \qquad ( 13 )$$

$${m}_{azx} = ( az\_xup - az\_xdown ) / 2 * 9.8 \qquad ( 14 )$$

where,
9.8 is the gravity, and
m_{axz} is the z acceleration sensed by x accelerometer.

The other elements of the misalignment matrix Ma can be similarly computed and are not shown for clarity.

In some implementations, gyroscope calibration can include determining gyroscope biases that can equal the average of gyroscope measurements at stationary state as:

$${b}_{g}^{sg} = mean ( {ω}_{stationary}^{sg} ) \qquad ( 15 )$$

where the ω_{stationary}^{sg} is the measurement in a stationary state.

In some implementations, a rotation angle of 180 degrees can be used during the flip of the box up/down along each axis, the gyro scale factor and misalignment along the rotation axis. For example, the x axis can be computed as follows:

$$[ {s}_{gx} {m}_{ayx} {m}_{azx} ] = \frac{{\int }_{t 0}^{t 1} ( {ω}_{x}^{sg} - {b}_{0}^{sg} ) dt}{π} \qquad ( 16 )$$

where the ωₓ^{sg} is the rotation vector, rotated 180 degrees between t0 and t1.

In some implementations, the y and z axis of the two gyroscope scale factors and misalignments can be similarly computed and are not shown for clarity. Briefly, computing the other two gyroscope scale factors and misalignment along y and z axis can be written as:

$$[ {m}_{axy} {s}_{gy} {m}_{azy} ] = \frac{{\int }_{t 0}^{t 1} ( {ω}_{y}^{sg} - {b}_{g}^{sg} ) dt}{π} \qquad ( 17 )$$

$$[ {m}_{axz} {m}_{ayz} {s}_{gz} ] = \frac{{\int }_{t 0}^{t 1} ( {ω}_{z}^{sg} - {b}_{g}^{sg} ) dt}{π} \qquad ( 18 )$$

In some implementations, converting the misalignment matrix of the accelerometer frame with respect to a reference frame (e.g., a reference box frame) to the up-triangle misalignment matrix which can be the misalignment matrix of the accelerometer sensor frame (non-orthogonal) with respect to the orthogonal accelerometer frame. Converting the misalignment matrix of an accelerometer frame can include calculating accelerometer tilt (A_tilt), transposing the accelerometer tilt (A_tilt_T), performing a QR factorization on the transposed accelerometer tilt, correcting the sign of the misalignment Matrix to make sure the diagonal elements are positive, and calculating the accelerometer misalignment. An example pseudo-code segment can be as follows:

A = (Sₐ + Mₐ)

| | |
|---|---|
| P = | [0 0 1 |
| | 0 1 0 |
| | 1 0 0]; |

A_tilt = P*A;
A_tilt_T = transpose(A_tilt);
% perform QR factorization on A_tilt_T
[Q_tilt, R_tilt] = qr(A_tilt_T);
% A = R*Q, R is the accelerometer misalignment matrix
Q = P*(Q_tilt.′);
R = P*(R_tilt.′)*P;
% correct sign of the misalignment Matrix to make sure the diagonal element are positive
T = diag([sign(R(1,1)), sign(R(2,2)), sign(R(3,3))]);
R = R*T;
Q_accel_box= T′*Q; % box frame to accel_orthonal frame
% calculate the accelerometer misalignment
Accel_misalignment = R;

In some implementations, converting the misalignment of the gyro frame with respect to the reference frame (e.g., a reference box frame) to the up-triangle misalignment matrix which is the misalignment matrix of the gyro sensor frame (non-orthogonal) to orthogonal gyro frame. Converting the misalignment matrix of the gyroscope frame can include calculating gyroscope tilt (A_tilt), transposing the gyroscope tilt (A_tilt_T), performing a QR decomposition on the transposed gyroscope tilt, correcting the sign of the misalignment Matrix to make sure the diagonal elements are positive, and calculating the gyrometer misalignment. An example pseudo-code segment can be as follows:

| | |
|---|---|
| P = | [0 0 1 |
| | 0 1 0 |
| | 1 0 0]; |

A_tilt = P*gyro_A;
A_tilt_T = transpose(A_tilt);
% perform QR decomposition: Orthogonal-triangular decomposition.
[Q_tilt, R_tilt] = qr(A_tilt_T);
% A = R*Q, R is the gyro misalignment matrix
Q = P*(Q_tilt.′);
R = P*(R_tilt.′)*P; % misalignment Matrix
% make diagonal element positive
T = diag([sign(R(1,1)), sign(R(2,2)), sign(R(3,3))]);
R = R*T;
% box frame to gyro_orthonal frame
Q_gyro_box = T′*Q;
% gyro_orthogonal frame to gyro sensor frame
gyro_misalignment = R;

Finally, in some implementations, a gyroscope quaternion format (e.g. Jet Propulsion Laboratory (JPL) quaternion) acceleration (gyro_q_accel) can be calculated from the orthogonal acceleration (accel_orthogonal) to the gyroscope orthogonal frame (gyro_orthogonal) using the following example pseudo-code.

% compute accel frame to gyro frame rotation matrix
gyro_R_accel = Q_gyro_box * (Q_accel_box)′;
% compute quaternion from rotation matrix
gyro_quat_accel_hamilton = rotm2quat(gyro_R_accel);
% convert hamilton quaternion to JPL quaternion.
if gyro_quat_accel_hamilton(1) > 0
gyro_quat_accel_JPL(4) = gyro_quat_accel_hamilton(1);
gyro_quat_accel_JPL(1:3) = − gyro_quat_accel_hamilton(2:4);
else
gyro_quat_accel_JPL(4) = − gyro_quat_accel_hamilton(1);
gyro_quat_accel_JPL(1:3) = gyro_quat_accel_hamilton(2:4);

In step S330 the intrinsic parameters are written (e.g., stored) in memory. For example, the accelerometer misalignment matrix and the gyroscope misalignment matrix can be stored in a memory associated with the IMU. For example, the accelerometer misalignment matrix and the gyroscope misalignment matrix can be stored in an Electrically Erasable Programmable Read-Only Memory (eeprom) of the IMU.

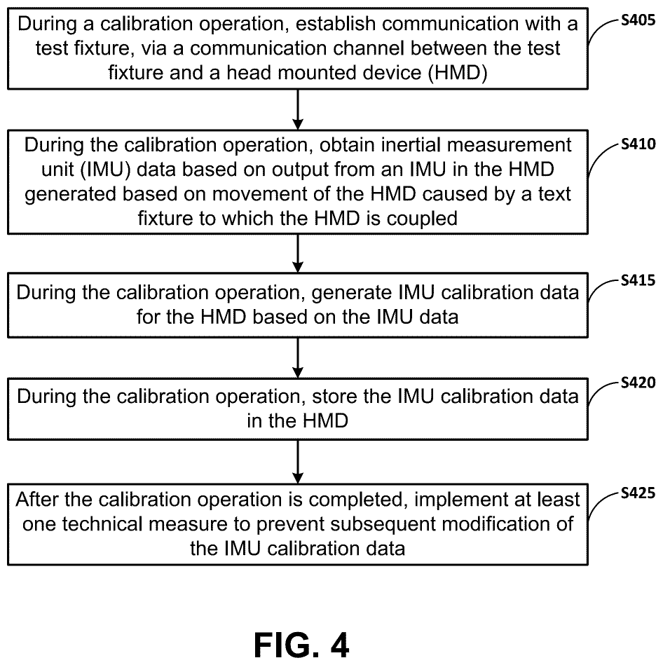

Example 1. FIG. 4 is a block diagram of a method of calibrating a wearable device IMU according to an example implementation. As shown in FIG. 4, in step S405, during a calibration operation, establishing communication with a test fixture, via a communication channel between the test fixture and a head mounted device (HMD). In step S410, during the calibration operation, obtaining inertial measurement unit (IMU) data based on output from an IMU in the HMD generated based on movement of the HMD caused by a text fixture to which the HMD is coupled. In step S415, during the calibration operation, generating IMU calibration data for the HMD based on the IMU data. In step S420, during the calibration operation, store the IMU calibration data in the HMD. In step S425, after the calibration operation is completed (or in response to completing the calibration operation), implement at least one technical measure designed to (configured to, intended to, arranged to, and the like) prevent subsequent modification of the IMU calibration data.

Example 2. The method of example 1, wherein the technical measure can include disabling the communication channel.

Example 3. The method of example 1, wherein the technical measure can include marking the IMU calibration data read only.

Example 4. The method of example 1, wherein the instructions can be further configured to cause the processor to initialize the text fixture using the communication channel.

Example 5. The method of example 1, wherein the obtaining of the IMU data can include obtaining the IMU data in response to a signal from the text fixture indicating movement of the HMD by the test fixture.

Example 6. The method of example 1, wherein the instructions can be further configured to cause the processor to store the IMU data.

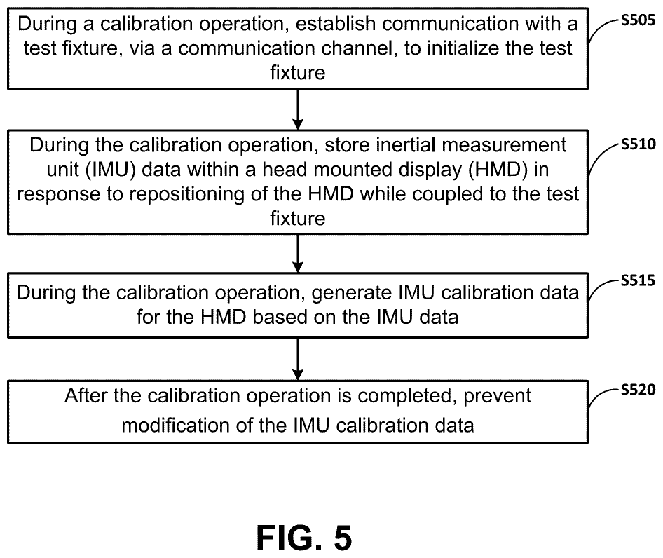

Example 7. FIG. 5 is a block diagram of a method of calibrating a wearable device IMU according to an example implementation. As shown in FIG. 4, in step S505, during a calibration operation, establish communication with a test fixture, via a communication channel, to initialize the test fixture. In step S510, during the calibration operation, store inertial measurement unit (IMU) data within a head mounted display (HMD) in response to repositioning of the HMD while coupled to the test fixture. In step S515, during the calibration operation, generate IMU calibration data for the HMD based on the IMU data. In step S520, after the calibration operation is completed (or in response to completing the calibration operation), prevent modification of the IMU calibration data.

Example 8. The method of example 1, wherein the preventing of the modification of the IMU calibration data can include disabling of the communication channel.

Example 9. The method of example 7, wherein the initializing of the test fixture can include communicating an initialization command that causes a levelling of the test fixture, the repositioning of the test fixture can include communicating a reposition command that causes the test fixture to move in at least one of three axes, and the disabling of the communication channel can cause the HMD to end the communication with the test fixture. In some implementations, the initializing of the test fixture can include activating the communication channel between the test fixture and the HMD. For example, in a default state the communication channel on the HMD can be disabled. If the calibration operation and/or process is controlled by the HMD, the HMD can enable the communication channel. If the calibration operation and/or process is controlled by the test fixture, the test fixture can cause the HMD to enable the communication channel. For example, an HMD command or routine that the test fixture has access to (e.g., via an open communication channel) can be triggered by the test fixture. The HMD command or routine can be configured to enable the communication channel. The HMD command or routine may not be accessible by any other device that does not include the test fixture.

Example 10. The method of example 7, wherein the IMU calibration data can include a gyroscope scale factor and a gyroscope misalignment along the rotation axis.

Example 11. The method of example 7, wherein the IMU calibration data can include an accelerometer misalignment matrix.

Example 12. The method of example 7, wherein the HMD can include two or more IMUs.

Example 13. The method of example 7, wherein IMU calibration data can be stored in a memory of the HMD.

Example 14. The method of example 7, wherein the instructions can be further configured to cause the processor to generate an accelerometer misalignment matrix indicating misalignment angles between an s frame and a p frame of the IMU based on the IMU calibration data.

Example 15. The method of example 7, wherein the instructions can be further configured to cause the processor to generate a gyroscope misalignment matrix indicating misalignment angles between an s frame and a p frame of the IMU based on the IMU calibration data.

Example 16. The method of any combination of one or more of Example 1 to Example 15, wherein the HMD is included in a box.

Example 17. A method can include any combination of one or more of Example 1 to Example 16.

Example 18. A non-transitory computer-readable storage medium comprising instructions stored thereon that, when executed by at least one processor, are configured to cause a computing system to perform the method of any of Examples 1-17.

Example 19. An apparatus comprising means for performing the method of any of Examples 1-17.

Example 20. An apparatus comprising at least one processor and at least one memory including computer program code, the at least one memory and the computer program code configured to, with the at least one processor, cause the apparatus at least to perform the method of any of Examples 1-17.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A non-transitory computer-readable storage medium comprising instructions stored thereon that, when executed by a processor, are configured to cause the processor to:
establish communication with a test fixture, via a communication channel between the test fixture and a head mounted device (HMD);
obtain inertial measurement unit (IMU) data based on output from an IMU in the HMD generated based on movement of the HMD caused by a text fixture to which the HMD is coupled;
generate IMU calibration data for the HMD based on the IMU data;
store the IMU calibration data in the HMD; and
implement at least one technical measure designed to prevent subsequent modification of the IMU calibration data.

2. The non-transitory computer-readable storage medium of claim 1, wherein the technical measure includes disabling the communication channel.

3. The non-transitory computer-readable storage medium of claim 1, wherein the technical measure includes marking the IMU calibration data read only.

4. The non-transitory computer-readable storage medium of claim 1, wherein the instructions are further configured to cause the processor to initialize the text fixture using the communication channel.

5. The non-transitory computer-readable storage medium of claim 1, wherein obtaining the IMU data includes obtaining the IMU data in response to a signal from the text fixture indicating movement of the HMD by the test fixture.

6. The non-transitory computer-readable storage medium of claim 1, wherein the instructions are further configured to cause the processor to store the IMU data.

7. The non-transitory computer-readable storage medium of claim 1, wherein the HMD is included in a box.

8. A non-transitory computer-readable storage medium comprising instructions stored thereon that, when executed by at least one processor, are configured to cause a processor to:
during a calibration operation:
establish communication with a test fixture, via a communication channel, to initialize the test fixture;
store inertial measurement unit (IMU) data within a head mounted display (HMD) in response to at least one of rotating or translating the HMD using the test fixture and while the HMD is coupled to the test fixture;
generate IMU calibration data for the HMD based on the IMU data; and
prevent, after the calibration operation is completed, modification of the IMU calibration data.

9. The non-transitory computer-readable storage medium of claim 8, wherein the preventing of the modification of the IMU calibration data includes disabling the communication channel.

10. The non-transitory computer-readable storage medium of claim 8, wherein
the initializing of the test fixture includes communicating an initialization command that causes a leveling of the test fixture,
the rotating or translating of the test fixture includes communicating a reposition command that causes the test fixture to move in at least one of three axes, and
the preventing of the modification of the IMU calibration causes the HMD to end the communication with the test fixture.

11. The non-transitory computer-readable storage medium of claim 8, wherein the IMU calibration data includes a gyroscope scale factor and a gyroscope misalignment along a rotation axis.

12. The non-transitory computer-readable storage medium of claim 8, wherein the IMU calibration data includes an accelerometer misalignment matrix.

13. The non-transitory computer-readable storage medium of claim 8, wherein the HMD includes two or more IMUs.

14. The non-transitory computer-readable storage medium of claim 8, wherein IMU calibration data is stored in a memory of the HMD.

15. The non-transitory computer-readable storage medium of claim 8, wherein the instructions are further configured to cause the processor to:
generate an accelerometer misalignment matrix indicating misalignment angles between an s frame and a p frame of the IMU based on the IMU calibration data.

16. The non-transitory computer-readable storage medium of claim 8, wherein the instructions are further configured to cause the processor to:
generate a gyroscope misalignment matrix indicating misalignment angles between an s frame and a p frame of the IMU based on the IMU calibration data.

17. The non-transitory computer-readable storage medium of claim 8, wherein the HMD is included in a box.

18. A non-transitory computer-readable storage medium comprising instructions stored thereon that, when executed by a processor, are configured to cause the processor to:
establish communication with a test fixture, via a communication channel, to initialize the test fixture;
initialize a test fixture coupled to a head mounted display (HMD);
rotate or translate the HMD while coupled to the test fixture;
in response to rotating or translating of the HMD,
record inertial measurement unit (IMU) data within the HMD;
generate IMU calibration data based on the IMU data; and
cause the HMD to prevent modification of the IMU calibration data.

19. The non-transitory computer-readable storage medium of claim 18, wherein
the initializing of the test fixture includes causing a leveling of the test fixture,
the rotating or translating of the test fixture includes moving the test fixture in at least one of three axes,
the recording of the IMU data includes receiving IMU data from the HMD, and
the preventing of the modification of the IMU calibration data causes the HMD to end the communication with the test fixture.

20. The non-transitory computer-readable storage medium of claim 18, wherein the HMD includes two or more IMUs.

21. The non-transitory computer-readable storage medium of claim 18, wherein IMU calibration data is stored in a memory of the HMD.

22. The non-transitory computer-readable storage medium of claim 18, wherein the instructions are further configured to cause the processor to:
generate an accelerometer misalignment matrix indicating misalignment angles between an s frame and a p frame of the IMU based on the IMU calibration data.

23. The non-transitory computer-readable storage medium of claim 18, wherein the instructions are further configured to cause the processor to:
generate a gyroscope misalignment matrix indicating misalignment angles between an s frame and a p frame of the IMU based on the IMU calibration data.

24. The non-transitory computer-readable storage medium of claim 18, wherein the HMD is included in a box.
